(19) United States
(12) Patent Application Publication
(10) Pub. No.: US 2016/0053969 A1
(43) Pub. Date: Feb. 25, 2016

(54) Lighting Charm

(71) Applicant: Hua-Cheng Pan, Tainan City (TW)

(72) Inventor: Chih-Liang Wang, Tainan (TW)

(21) Appl. No.: 14/462,568

(22) Filed: Aug. 19, 2014

(51) Int. Cl. F21V 11/16; F21V 23/04; F21V 33/00

(52) U.S. Cl. CPC F21V 11/16; F21V 33/0028; F21V 23/04; F21W 2121/006

(57) ABSTRACT

A lighting charm mainly includes a mask, a first cover, a second cover as provided with an illuminator and a switch. The first and second covers are positioned at two sides of the mask respectively while the switch is used to turn on or off the illuminator. According to the aforesaid, the illuminator distributes a light over the mask so as to enrich an effect of light and shade and thus enhance the visual sensation of the present invention.

### TECHNICAL FIELD OF THE INVENTION

The present invention is related to a lighting charm, particularly an object designed for a visual effect by furnishing within a specific environment.

### DESCRIPTION OF THE PRIOR ART

Usually a charm for decorating a specific environment is of a simple design in structure without many variations. Recently living standard of people has increased and market demand on decorating lights, which are used to embellish environment or enhance visual effect, has increased as well. The decorating lights are further improved for producing a specific atmosphere or visual effect in order to attract consumers, increase their will of purchasing and strengthen product competitiveness.

In addition, during a decoration construction a consumer frequently needs to consider other furniture as part of an integral design that decorating lights of different appearances and functions are required accordingly. Therefore the current vendors of decorating lights more focus on various appearance designs.

### SUMMARY OF THE INVENTION

An objective of the present invention is to enrich the visual effect of a decorating charm in order to strengthen its competitiveness.

Therefore the present invention is to provide a lighting charm that mainly includes:
a mask, hollow and transparent, at a bottom provided with a lower opening physically connecting with an internal space;
a first cover as positioned at one side of the mask;
a second cover, as positioned at the other side of the mask with respect to the first cover, provided with a platform for sealing the lower opening of the mask, a support for securing to an underside of the platform by threading, a control circuit and at least an illuminator as electrically connected therewith and oriented toward the internal space of the mask; and
a switch as electrically connected with the control circuit.

Thereby when the present invention is turned on with electricity supplied, the illuminator will distribute a light over the mask so as to enrich an effect of light and shade and thus enhance the visual sensation of the present invention.

### BRIEF DESCRIPTION OF THE DRAWINGS

FIG. 1 is a schematic diagram illustrating an assembly of a preferred embodiment of the present invention.

FIG. 2 is a schematic diagram illustrating a disassembly of the preferred embodiment of the present invention.

FIG. 3 is a schematic diagram illustrating a cross-section of the preferred embodiment of the present invention.

FIG. 3a is a schematic diagram illustrating a local enlarged view of FIG. 3.

FIG. 4 is a schematic diagram illustrating a cross-section as electricity supplied to the preferred embodiment of the present invention.

FIG. 4a is a schematic diagram illustrating a local enlarged view of FIG. 4.

FIG. 5 is a schematic diagram illustrating an assembly of the other preferred embodiment of the present invention.

FIG. 6 is a schematic diagram illustrating a disassembly of the other preferred embodiment of the present invention.

FIG. 7 is a schematic diagram illustrating an operation of the other preferred embodiment of the present invention.

### DETAILED DESCRIPTION OF THE PREFERRED EMBODIMENTS

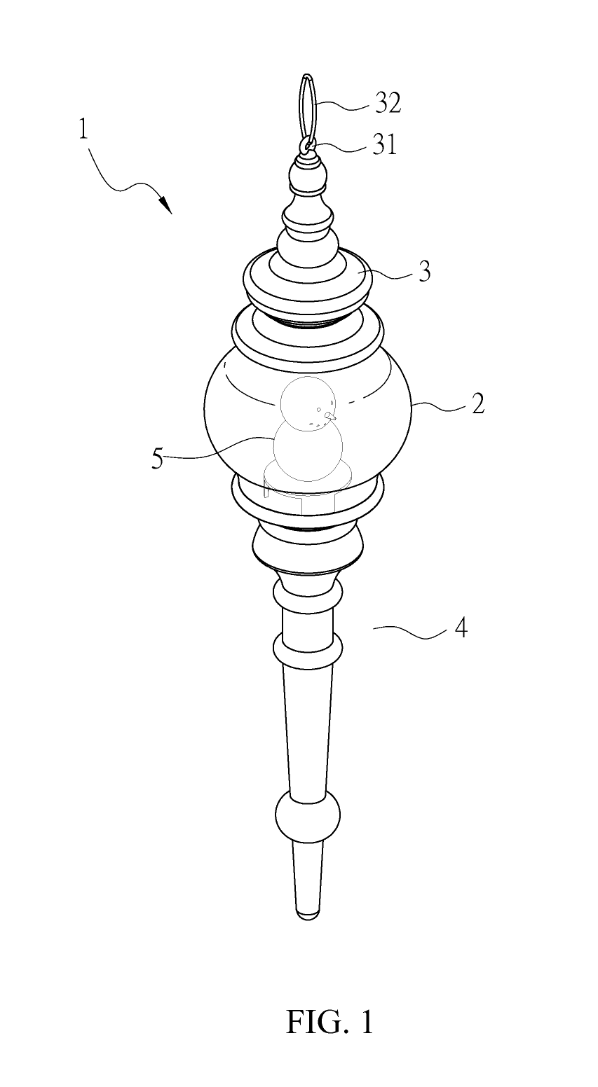

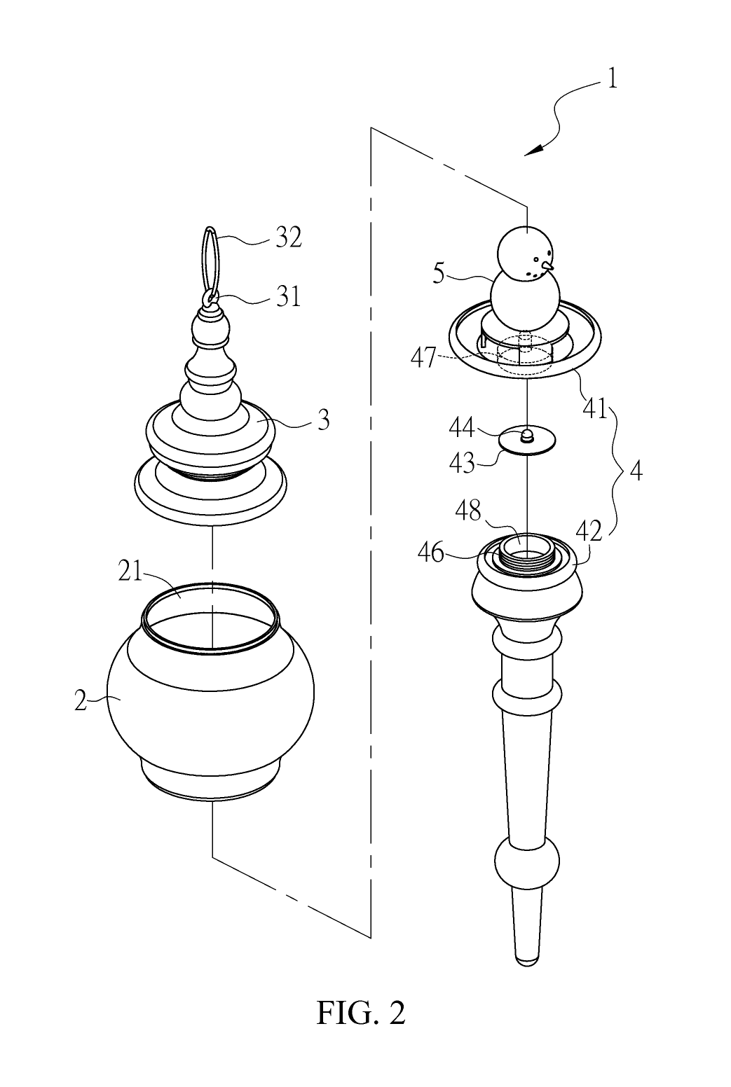

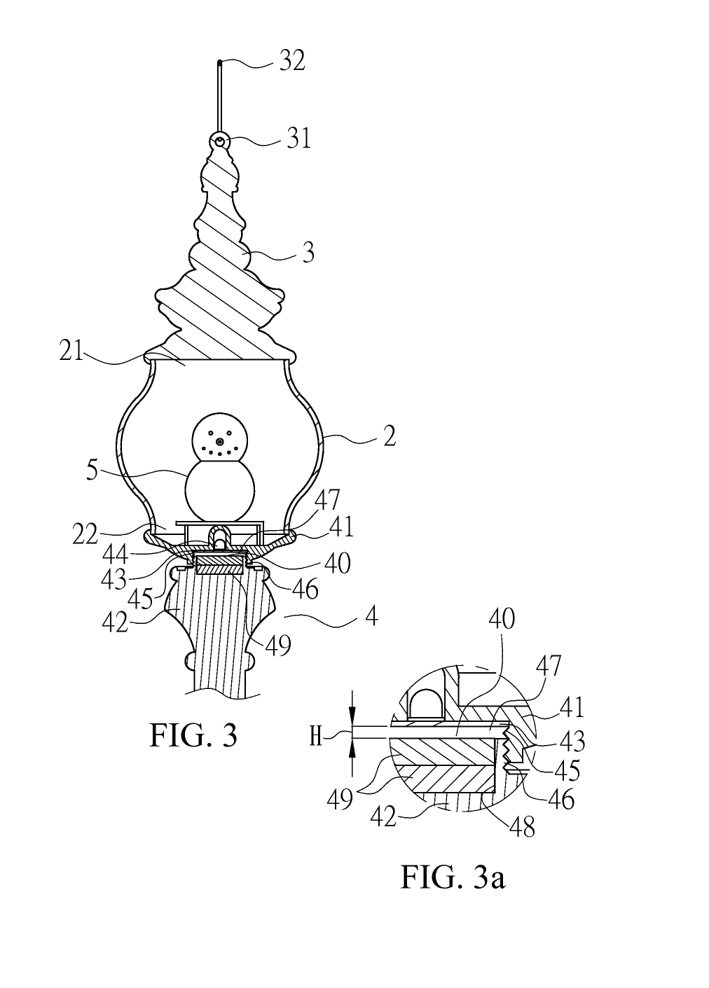

Please refer FIGS. 1 to 3a illustrating a preferred embodiment of a lighting charm (1) of the present invention suitable as a hanging structure for decorating an environment that mainly includes a mask (2), a first cover (3), a second cover (4) and a transparent ornament (5). The first cover (3) and the second cover (4) are respectively positioned at a top and a bottom of the mask (2) while the transparent ornament (5) is positioned at the second cover (4) and inside the mask (2). In this embodiment the mask (2), the first cover (3), the second cover (4) and the transparent ornament (5) are made of transparent substance such as plastic, glass and so on.

The mask (2) is hollow and transparent in a sphere shape in this embodiment for illustration purpose. The mask (2) is provided with an upper opening (21) and a lower opening (22) at the top and the bottom of the mask (2) respectively for physically connecting with an internal space thereof.

The first cover (3) is positioned at the top of the mask (2) for sealing the upper opening (21). In this preferred embodiment the first cover (3) is configured by multiply cylinders at different diameters as arranged continuously into a tower appearance for illustration purpose instead of limitation thereon. Further a hanging piece (31) is provided at a tip of the first cover (3) as an extension thereof in a shape of a ring or a hook that in this preferred embodiment a ring is used for illustration purpose. The lighting charm of the present invention can use the hanging piece (31) or a flexible line (32), which is winded through the hanging piece (31) as shown in FIG. 1, for suspension.

The second cover (4) is provided with a platform (41), which is to seal the lower opening (22) of the mask (2), and a support (42), which is positioned at an underside of the platform (41). The second cover (4) is further provided with a control circuit (43) and at least an illuminator (44), which is oriented toward the internal space of the mask (2) and electrically connected with the control circuit (43).

The support (42) is secured to the platform (41) by threading that the underside of the platform (41) is provided with an internal thread (45) and the support (42) is provided with a corresponding external thread (46) so as to be secured to the platform (41) by threading. The platform (41) is further provided with a downward trench (47) and the support (42) is also provided with a corresponding slot (48) that in this preferred embodiment the internal thread (45) is provided at an inner sidewall of the trench (47) while the external thread (46) is provided at an outer sidewall of the slot (48). Therefore a storing space (40) is constituted as the trench (47) is engaged with the slot (48) so as to accommodate the illuminator (44), the control circuit (43) and a battery (49) in a sequence from top to bottom inside the storing space (40) that the control circuit (43) is secured to the trench (47) and the battery (49) is placed inside the slot (48). In this preferred embodiment one illuminator (44) is used for illustration purpose instead of limitation on its quantity. The illuminator (44) is a LED bulb and its flashing frequency and changing color are controlled by the control circuit (43).

The transparent ornament (5) is in a transparent three-dimension shape, which is positioned at the platform (41) inside the mask (2), to receive an illumination by the illuminator (44) that the transparent ornament (5) is secured to the platform (41) by adhesive, screw or other means. In this embodiment the transparent ornament (5) is a transparent extension from the platform (41) for illustration purpose.

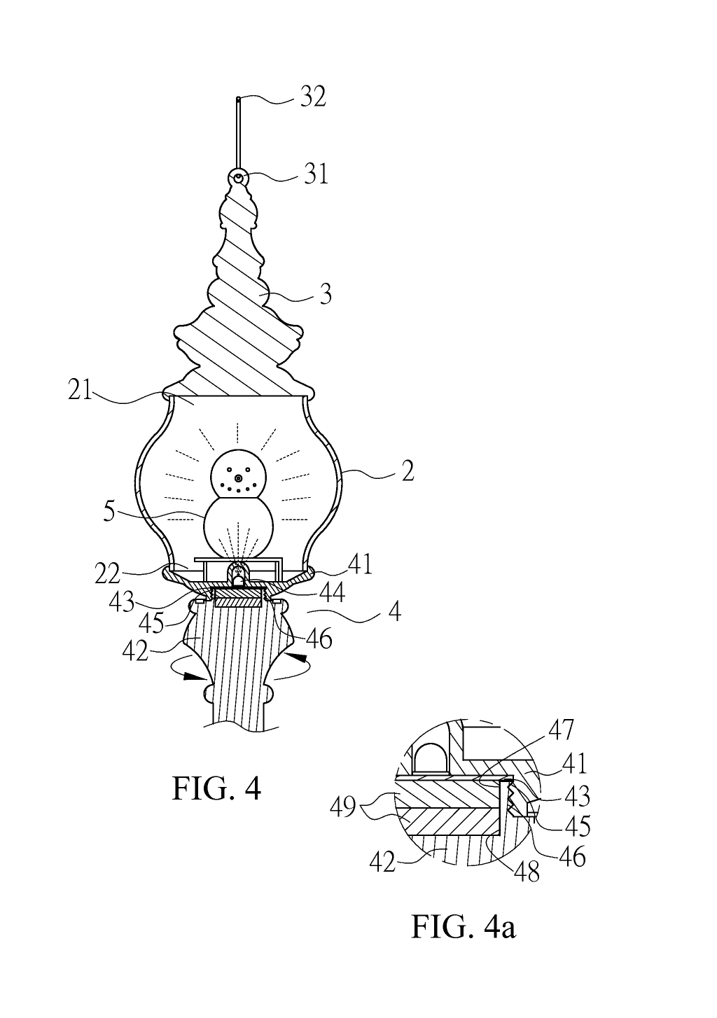

Please refer FIGS. 4 and 4a. When the support (42) is disengaged with the platform (41), the battery (49), which is correlated with the slot (48), is out of contact with the control circuit (43) at a clearance (H) that the battery (49) is not conducted with the control circuit (43). A length of the external thread (46) of the support (42) can be adjusted in order to tighten the external thread (46) toward the platform (41) and the battery (49) as correlated with the slot (48) is therefore approaching the control circuit (43) till a conduction for supply electricity so as to turn on the illuminator (44). Consequently the illuminator (44) will distribute a light over the ornament (5) while a portion of the light will pass to the mask (2) and the first cover (3) for producing an effect of light and shade. Thus the present invention carries an enriched visual effect beyond the charm appearance.

According to the above-mentioned, the first cover (3) can be provided with a control circuit (not shown) and at least an illuminator (not shown), which is electrically connected with the control circuit (not shown), as oriented toward the internal space of the mask (2) while the second cover (4) also can be provided with a hanging piece (not shown). According to the aforesaid, the control circuit (43), the illuminator (44) and the hanging piece (31) can be positioned at either one or both of the first cover (3) and the second cover (4) so as to realize a broad variety of the present invention.

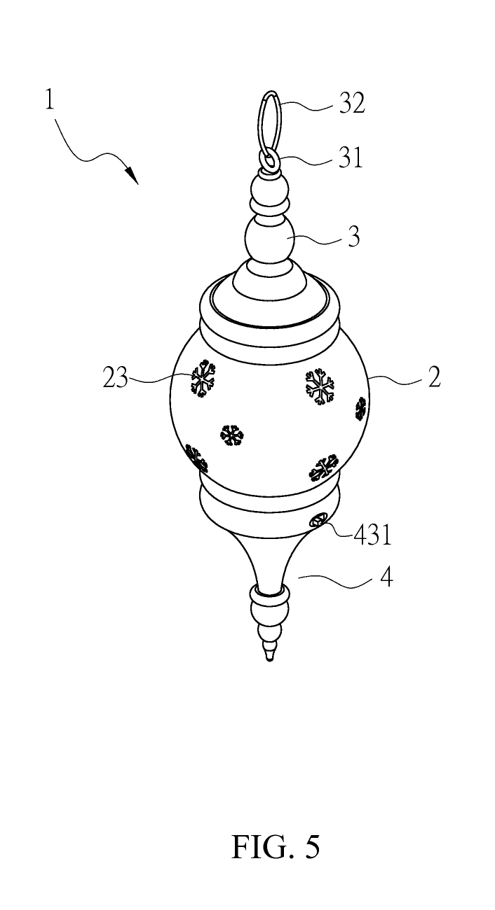

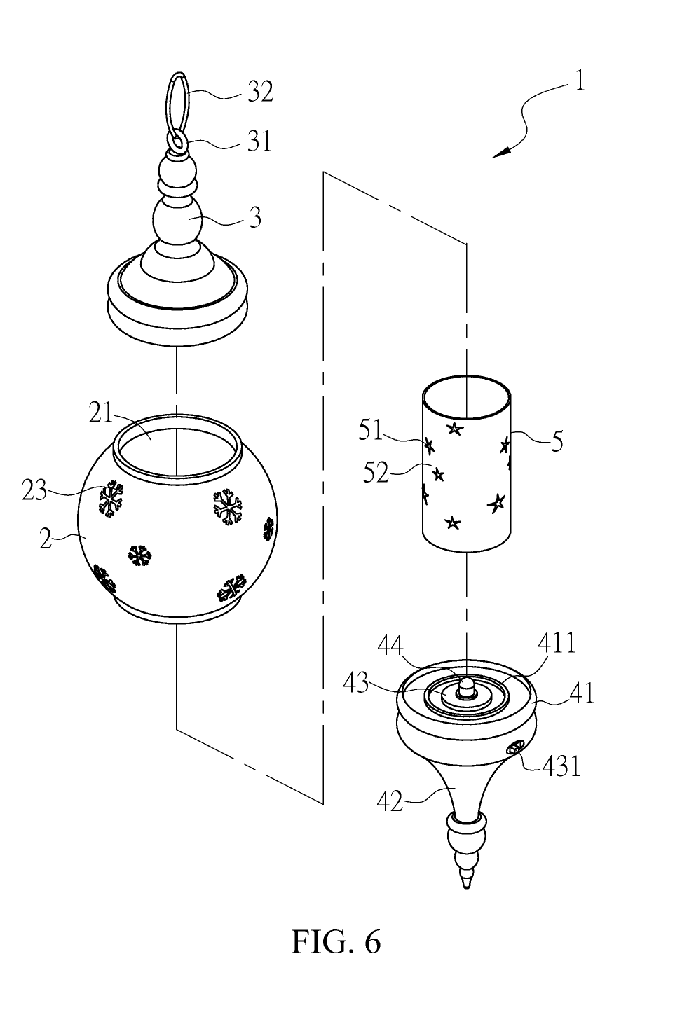

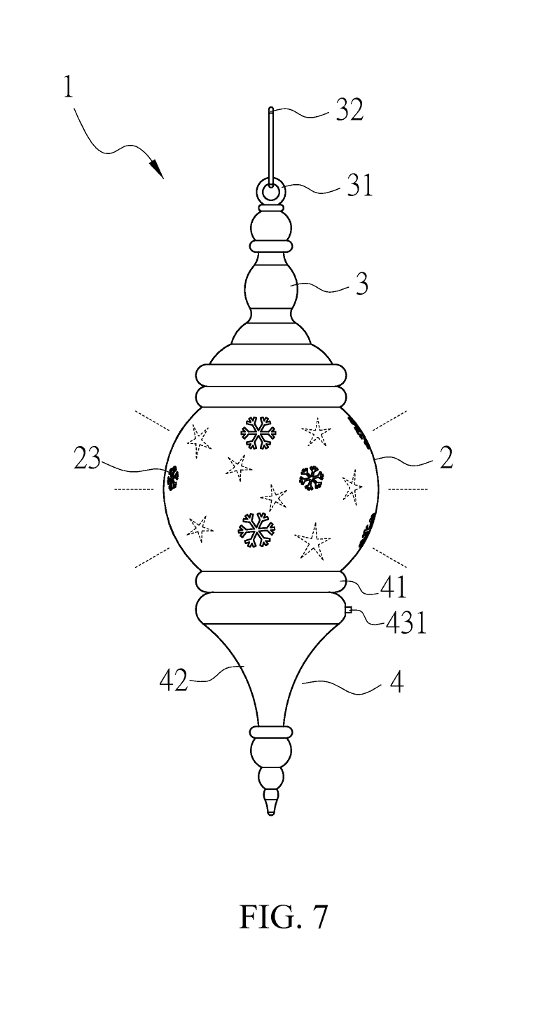

FIGS. 5, 6 and 7 are schematic diagrams illustrating an assembly, disassembly and operation of the other preferred embodiment of the present invention. As shown in FIGS. 5 to 7, the lighting charm (1) mainly includes a mask (2), a first cover (3), a second cover (4) and a transparent ornament (5). The first cover (3) and the second cover (4) are screwed to a top and a bottom of the mask (2) respectively. The ornament (5) is positioned at the second cover (4) and inside the mask (2). Major structure of this embodiment is the same as the preferred embodiment of FIG. 1 so that only the deviation is described herewith.

A sidewall of the mask (2) is by matte treatment or with texture that the matte treatment with multiply transparent areas (23) of predetermined textures is used for illustration purpose in this embodiment. Further the second cover (4) is provided with a platform (41) and a support (42), which is an extension thereof, that the control circuit (43) and the illuminator (44) are positioned at the platform (41). An outer circumference of the second cover (4) is provided with a switch (431), which is electrically connected with the control circuit (43) and positioned at an outer circumference of the support (42) in this embodiment, while the location of the switch (431) limited since it can be positioned at an outer circumference of the platform (41) as well. The switch (431) is used to turn on or off the illuminator (44) while the sources of electricity can be one of a battery, an alternate current supply or a direct current supply that the electricity sources are of broad variety and thus omitted as its absence in the scope of claim of the present invention.

Moreover, the transparent ornament (5) is a projecting slide, which is in a cylinder shape to encircle the illuminator (44), and the platform (41) is provided with a flange (411), which has an outer side to be positioned by the projecting slide with an application of adhesive so as to securely integrate the projecting slide to the flange (411). The transparent ornament (5) is provided with a transparent area (51), which can be in a form of a figure, character or geometric texture and so on, and an opaque area (52) that multiply star shapes are used for illustration purpose. The projecting slide of this embodiment is a transparent and flexible film made of plastic substance while the opaque area (52) is shaded by painting, taping or other means in order to block the light transmission that the untreated area becomes transparent.

According to the above-mentioned, when the present invention is turned on with electricity supplied, the light from the illuminator (44) will project the contour of the transparent area (51) of the transparent ornament (5) to the sidewall of the mask (2) in correspondence with the transparent area (23) thereof. Further a portion of light will pass through the transparent area (23) of the mask (2) so as to enrich the visual effect of light and shade of the present invention.

I claim:

1. A lighting charm comprising
a mask, hollow and transparent with a lower opening at bottom physically connected with an internal space;
a first cover, positioned at one side of said mask; and
a second cover, positioned at the other side of said mask with respect to said first cover, provided with a platform for sealing the lower opening and a support as connected to an underside of the platform by threading, said second cover further provided with a control circuit, at least an illuminator as electrically connected therewith and oriented toward the internal space of said mask and a switch as electrically connected with the control circuit.

2. The lighting charm of claim 1 wherein further includes a transparent ornament in three-dimensional form as positioned at the platform and inside said mask for receiving illumination by the illuminator.

3. The lighting charm of claim 2 wherein the platform is transparent and the transparent ornament is extended from the platform.

4. The lighting charm of claim 1 wherein a hanging piece is provided at a tip of either said first cover or said second cover.

5. The lighting charm of claim 1 wherein the transparent ornament is a projecting slide, encircling the illuminator, as provided with a transparent area and an opaque area.

6. The lighting charm of claim 5 wherein the transparent area is in a form of figure or character.

7. The lighting charm of claim 5 wherein the support of said second cover is extended from the platform thereof.

8. The lighting charm of claim 2 wherein said first cover is secured to said mask by screw and provided with a control circuit and at least an illuminator that is electrically connected therewith and oriented toward the internal space of said mask.
